(19) United States
(12) Patent Application Publication
(10) Pub. No.: US 2017/0372077 A1
(43) Pub. Date: Dec. 28, 2017

(54) SELECTIVE DATA ENCRYPTION

(71) Applicant: International Business Machines Corporation, Armonk, NY (US)

(72) Inventors: Dario D'Angelo, Los Gatos, CA (US); Thomas R. Sullivan, San Jose, CA (US)

(21) Appl. No.: 15/190,476

(22) Filed: Jun. 23, 2016

(51) Int. Cl. G06F 21/60

(52) U.S. Cl. CPC G06F 21/602

(57) ABSTRACT

As disclosed herein a computer-implemented method includes receiving a request to perform selective data encryption on captured content corresponding to a computing device. The method further includes determining whether the captured content includes encoded printable characters, and responsive to determining that the captured content includes the encoded printable characters, encrypting the encoded printable characters within the captured content to provide encrypted captured content. A computer program product and a computer system corresponding to the above method are also disclosed herein.

### BACKGROUND

The present invention relates generally to data encryption, and more particularly to selectively encrypting only portions of the data.

Many times a support team is engaged when a computing device experiences operational malfunctions or errors. During problem analysis, the support team may request that the system administrator of the malfunctioning system provide captured data (e.g., dumps, logs, or the like) corresponding to the errors. The captured data may include sensitive or confidential information that should not be transmitted or transported to the support team in human readable format. To prevent unintentional disclosure of the sensitive or confidential information, the captured data may be encrypted by the administrator prior to being transmitted. The support team may be provided the encrypted data and the encryption key required to decrypt the encrypted data in different transmissions. After the support team is in possession of both the encrypted data and the encryption key, they can decrypt the captured data and begin analysis and problem determination.

### SUMMARY

As disclosed herein a computer-implemented method includes receiving a request to perform selective data encryption on captured content corresponding to a computing device. The method further includes determining whether the captured content includes encoded printable characters, and responsive to determining that the captured content includes the encoded printable characters, encrypting the encoded printable characters within the captured content to provide encrypted captured content. A computer program product and a computer system corresponding to the above method are also disclosed herein.

### BRIEF DESCRIPTION OF THE DRAWINGS

FIG. 1 is a functional block diagram depicting a computing environment, in accordance with at least one embodiment of the present invention;

FIG. 2 is a flowchart depicting a selective encryption method, in accordance with at least one embodiment of the present invention;

FIG. 3A depicts example unencrypted dump data, in accordance with at least one embodiment of the present invention;

FIG. 3B depicts example dump data after selective encryption, in accordance with at least one embodiment of the present invention; and

FIG. 4 is a functional block diagram depicting various components of one embodiment of a computer suitable for executing the methods disclosed herein.

### DETAILED DESCRIPTION

Corporations rely on computers to manage and maintain many aspects of their day to day business operations. When the computers malfunction, the corporations may engage the services of a support team to perform problem analysis. To perform problem analysis, the support team may request captured data (e.g., dumps, logs, or the like) from the malfunctioning computer.

The captured data may be a subsystem memory dump (e.g., a static picture of the memory of a computer at the time the malfunction occurred), log files containing information captured over time, or any other collection of data familiar to those of skill in the art. The captured data, hereinafter dump, may contain unformatted encoded printable characters that represent sensitive or confidential customer data. In most situations the customer data is not required to perform the problem analysis. It has been observed that encrypting the entire dump protects the customer data from being accidentally disclosed while the dump is being transferred to the support team. However, once the support team decrypts the dump, the customer data is again visible. If only the encoded printable characters (e.g., customer data) were selectively encrypted, then the support team may be able to analyze the dump without decrypting the selectively encrypted data (i.e., encrypted encoded printable characters), thus preventing unintended disclosure of sensitive or confidential customer data.

The embodiments disclosed herein recognize that selectively encrypting only the encoded printable characters included in the dump may reduce time, computational overhead, and resource required to produce a dump that can be securely transferred to the support team. Additionally, selectively encrypting only the encoded printable characters may enable the support team to perform problem analysis without performing any decryption operations. The present invention leverages the above observations and will now be described in detail with reference to the Figures.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter.

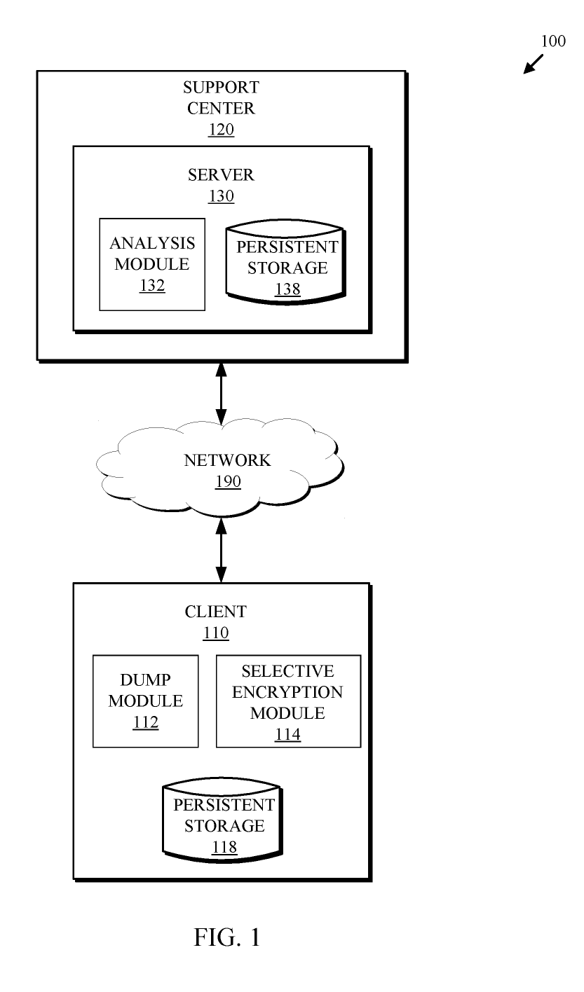

FIG. 1 is a functional block diagram depicting a computing environment 100, in accordance with at least one embodiment of the present invention. Computing environment 100 includes client 110 and support center 120 that communicate with each other over network 190.

Client 110 includes dump module 112, selective encryption module 114 and persistent storage 118. Support center 120 includes server 130, that may be used by support teams (not shown) to assist with analyzing dumps received from clients (e.g., client 110). Server 130 includes analysis module 132 and persistent storage 138. Client 110 and server 130 can be computing devices such as smart phones, tablets, desktop computers, laptop computers, specialized computer servers, or the like that are capable of processing instructions and communicating over network 190.

If a computing subsystem with in client 110 malfunctions, then a user or administrator of client 110 may request assistance with problem analysis from support center 120. A support team corresponding to support center 120 may request that information corresponding to the malfunction be provided. The request from the support team may include a request for one or more memory dumps corresponding to the subsystem at the time of the malfunction. In some embodiments, dump module 112 is configured to produce a system dump each time any subsystem of client 110 malfunctions. In other embodiments, a system administrator enables dump module 112 to produce a dump and subsequently the scenario causing the malfunction is recreated and a dump is created. The resulting dump may be stored on persistent storage 118.

The dump may include encoded printable characters that can be easily detected and viewed by the human eye or dump analysis tools. It is possible that the encoded printable characters may represent sensitive or confidential information that should not be disclosed to those viewing the dump. The encoded printable characters may be encoded using one of many encoding formats familiar to those of skill in the art (e.g., extended binary coded decimal interchange code (EBCDIC), American Standard Code for Information Interchange (ASCII), or Unicode).

Prior to providing the dump to the support team, the administrator of client 110 may wish to selectively encrypt the encoded printable characters contained within the dump. Selective encryption module 114 may be configured to detect encoded printable characters in a dump and selectively encrypt only the encoded printable characters, leaving the additional data in the dump unaltered and usable. In some embodiments, selective encryption module 114 stores an encryption key corresponding to the selectively encrypted dump in a secure location on persistent storage 118. In other embodiments, selective encryption module 114 provides an encryption key, corresponding to the selectively encrypted dump, to the administrator of client 110. Encrypting only the encoded printable characters may reduce both the time and resource required to securely provide the dump to support center 120.

The selectively encrypted dump and any other information provided by client 110 may be transmitted from client 110 to support center 120 over network 190. Server 130 within support center 120 may receive the selectively encrypted dump from client 110. Server 130 may store the dump and any other information on persistent storage 138. Persistent storage 118 and 138 may be any non-volatile storage device or media known in the art. For example, persistent storage 118 and 138 can be implemented with a tape library, optical library, solid state storage, one or more independent hard disk drives, or multiple hard disk drives in a redundant array of independent disks (RAID). Similarly, data on persistent storage 118 and 138 may conform to any suitable storage architecture known in the art, such as a file, a relational database, an object-oriented database, and/or one or more tables.

When the support team begins analyzing the dump, the team may use dump analysis tools such as analysis module 132. Analysis module 132 may be configured to process information contained in the selectively encrypted dump. The analysis operations may be able to be successfully performed without decrypting the encoded printable characters. In scenarios where decrypting of the encoded printable characters is required, the administrator of client 110 may provide the encryption key to the support team enabling them to decrypt the encoded printable characters. In the depicted embodiment, selective encryption module 114 is included in client 110. In other embodiments, selective encryption module 114 is a remotely located web application that communicates with client 110 and provides selective encryption services via network 190.

Client 110, server 130, and other electronic devices (not shown) communicate over network 190. Network 190 can be, for example, a local area network (LAN), a wide area network (WAN) such as the Internet, or a combination of the two, and include wired, wireless, or fiber optic connections. In general, network 190 can be any combination of connections and protocols that will support communications between client 110 and server 130 in accordance with at least one embodiment of the present invention.

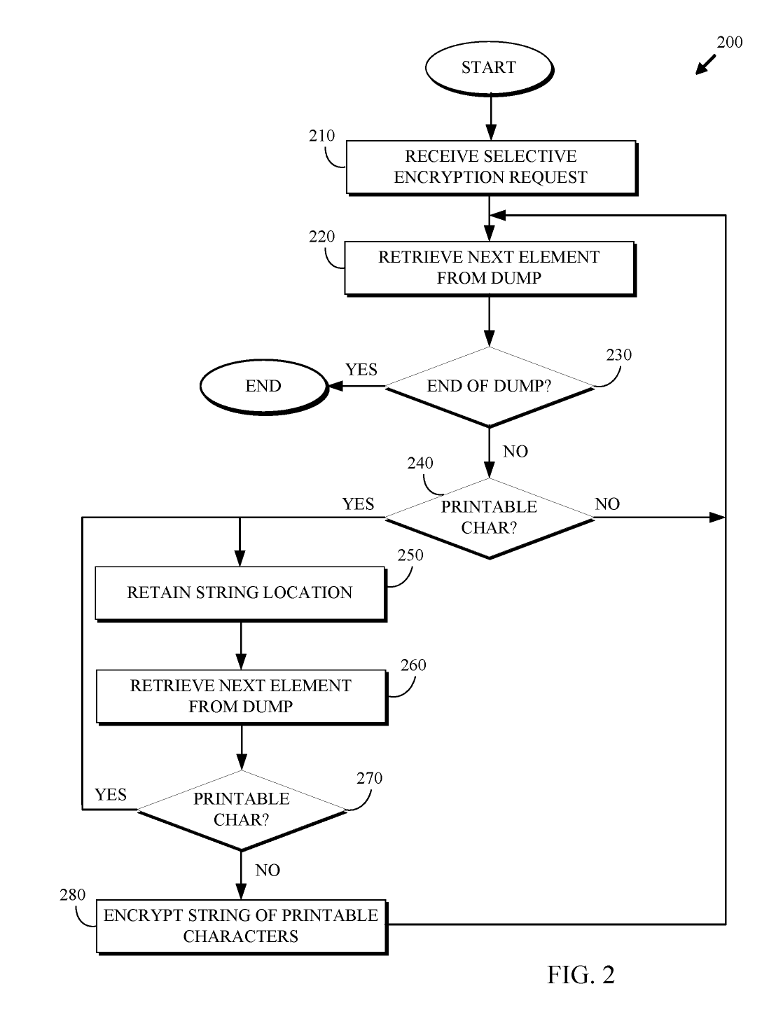

FIG. 2 is a flowchart depicting selective encryption method 200, in accordance with at least one embodiment of the present invention. As depicted, selective encryption method 200 includes receiving (210) a selective encryption request, retrieving (220) the next element from the dump, determining (230) whether the end of the dump has been reached, determining (240) whether the element is an encoded printable character, retaining (250) the string location, retrieving (260) the next element from the dump, determining (270) whether the element is an encoded printable character, and encrypting (280) a string of printable characters. Selective encryption method 200 enables selective encryption module 114 detect and selectively encrypt only the encoded printable characters within content captured from a computing device (e.g., a dump).

Receiving (210) a selective encryption request may include selective encryption module 114 being notified a that selective encryption is desired on a dump. In some embodiments, the a selective encryption request includes identifiers that determine the type and strength of encryption algorithm to be used during the selective encryption operation. In some embodiments, the a selective encryption request and the dump are received directly from dump module 112. In other embodiments, the a selective encryption request is initiated by a system administrator, and the dump is retrieved from persistent storage 118.

Retrieving (220) the next element from the dump may include selective encryption module 114 determining if this is the first read attempt against the file containing the dump, and if so, opening the file containing the dump and initializing a read pointer to the beginning of the dump. In some embodiments, only the a single element of the dump is retrieved (e.g., read). In other embodiments, multiple elements are read, placed in an input buffer and processed one at a time from the buffer. When the input buffer is empty, additional elements are read and placed in the input buffer. An element may be any basic unit that is required to represent a single encoded printable character (e.g., a byte).

Determining (230) whether the end of the dump has been reached may include selective encryption module 114 detecting that the last element of the dump has been processed. If the end of the dump has been reached, then selective encryption method 200 ends. Otherwise, selective encryption method 200 proceeds to the determining operation 240.

Determining (240) whether the element is an encoded printable character may include selective encryption module 114 determining which encoding format that has been used to encode the information in the dump (e.g., EBCDIC, ASCII, Unicode). In some embodiments, the encoding format is provided to encryption module as an input parameter with the encryption request. In other embodiments, the encoding format is encoded in the dump file. In some embodiments, a translate table is used to determine if the element is an encoded printable character. In other embodiments, a branch table is used to determine if the element is an encoded printable character. Those with skill in the art will realize there are other ways to determine if the element is an encoded printable character. If the element is an encoded printable character the selective encryption method 200 proceeds to the retain string location operation 250. Otherwise, selective encryption method 200 proceeds to the retrieve the next element operation 220.

Retaining (250) the string location may include selective encryption module 114 identifying the location of a contiguous string of encoded printable characters. In some embodiments, selective encryption module 114 retains the physical location of the first encoded printable character and the location of the current encoded printable character, thus identifying the beginning and end of the current string of contiguous encoded printable characters. In other embodiments, as each character of a string of encoded printable characters is a detected, selective encryption module 114 places the encoded printable characters in a buffer to be encrypted at a later time.

Retrieving (260) the next element from the dump may include selective encryption module 114 referencing a read pointer to determine the next element from the dump to be retrieved. In some embodiments, a single element of the dump is retrieved (e.g., read) directly from the file containing the dump. In other embodiments, a buffered read operation places elements from the dump into an input buffer, and the next element is retrieved from the input buffer.

Determining (270) whether the element is an encoded printable character may include selective encryption module 114 performing the same operations that are performed in determining operation 240. If the element is an encoded printable character the selective encryption method 200 proceeds to the retain string location operation 250. Otherwise, selective encryption method 200 proceeds to the encrypt operation 280.

Encrypting (280) a string of printable characters may include selective encryption module 114 requesting that a string of encoded printable characters be encrypted. In some embodiments, selective encryption module 114 performs the encryption operations. In other embodiments, selective encryption module 114 passes the encryption request to an external encryption module (not shown).

In some embodiments, the string of encoded printable characters that is to be encrypted is provided to the encryption routine in a buffer. In other embodiments, references (e.g., pointers) to the location of the string in the dump are passed to the encryption routine. In some embodiments, a copy of the dump is created and the encoded printable characters are encrypted in the new copy of the dump, thus preserving the original copy of the dump. In other embodiments, the encoded printable characters are encrypted in place within the original copy of the dump. In another embodiment, all encoded printable characters included in the dump are identified, and then selective encryption module 114 makes a single request to encrypt all encoded printable characters that were identified in the dump.

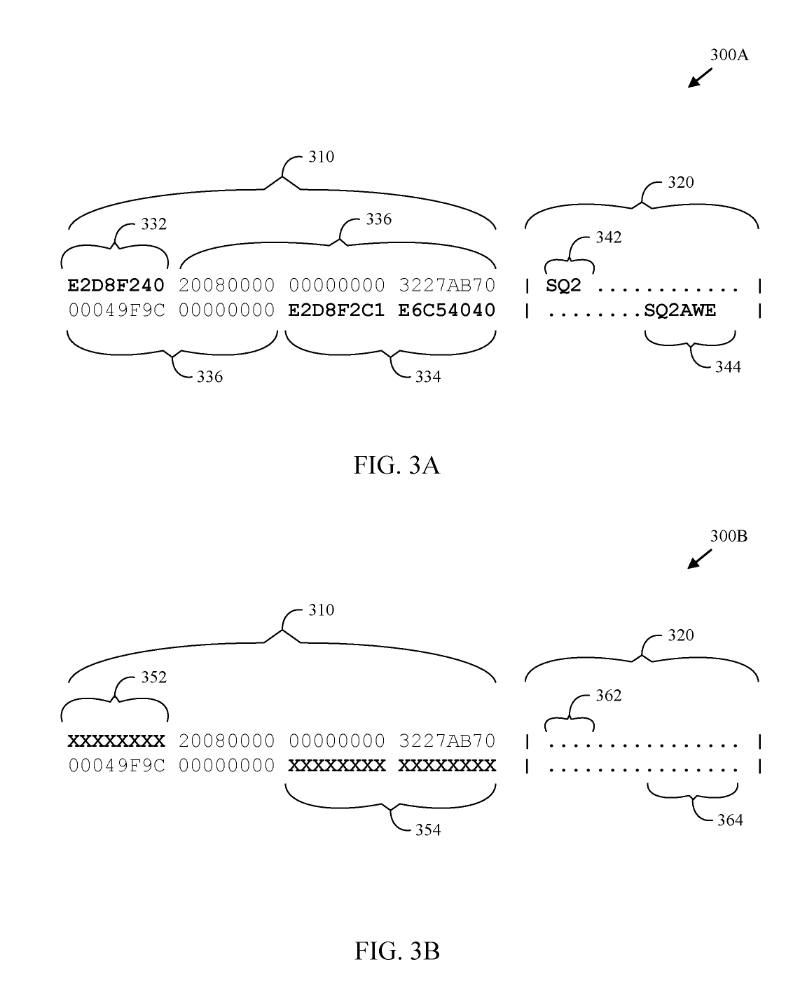

FIG. 3A depicts example dump data 300A, that may have been created by dump module 112, in accordance with at least one embodiment of the present invention. The example dump data 300A includes EBCDIC encoded data 310 and a printable translation 320 of the EBCDIC encoded data 310. The EBCDIC encoded data 310 includes unformatted dump data. The EBCDIC encoded data 310 includes two strings of EBCDIC encoded printable characters (string 332 and 334) and non-printable data 336. The printable translation 320 includes a printable representation of the EBCDIC encoded data 310. Printable characters are presented in human readable form. For example, string 332 is represented in printable translation 320 by string 342 (i.e., “SQ2”) and string 334 is represented by string 344 (i.e., “SQ2AWE”). Any non-printable character is represented in printable translation 320 by a dot (i.e., “.”).

Example dump data 300A contains printable encoded characters (e.g., strings 332 and 334) that are easily translated into human readable data. The information represented by the printable characters may be sensitive or confidential in nature. If example dump data 300A is to be provided to a support center (e.g., support center 120) for analysis of a system malfunction, then the printable encoded characters (e.g., strings 332 and 334) should be encrypted to prevent inadvertent disclosure of any sensitive or confidential information.

Prior to providing the example dump data 300A to support center 120, the example dump data 300A may be selectively encrypted using selective encryption module 114. Selective encryption module 114 may take as input example dump data 300A, detect and encrypt encoded printable characters, and provide selectively encrypted dump data 300B, as depicted by FIG. 3B. In the encrypted dump data 300B a selectively encrypted character is represented by ‘XX’. Depending on the encryption algorithm used, the size (e.g., length) of the encrypted data may differ from the original unencrypted data. Encrypted dump data 300B includes encrypted strings 352 and 354 which are the selectively encrypted representation of strings 332 and 334, respectively. Printable translation 320 of FIG. 3B includes non-printable characters (strings) 362 and 364 that represent the selectively encrypted strings (352 and 354) and present them as non-printable characters. After the selective encryption operation has completed, each encoded non-printable character in example dump data 300A remains unaltered in encrypted dump data 300B. Selectively encrypting the encoded printable characters, and leaving the encoded non-printable characters unaltered enables analysis of the dump without disclosing the content of an potentially sensitive or confidential data.

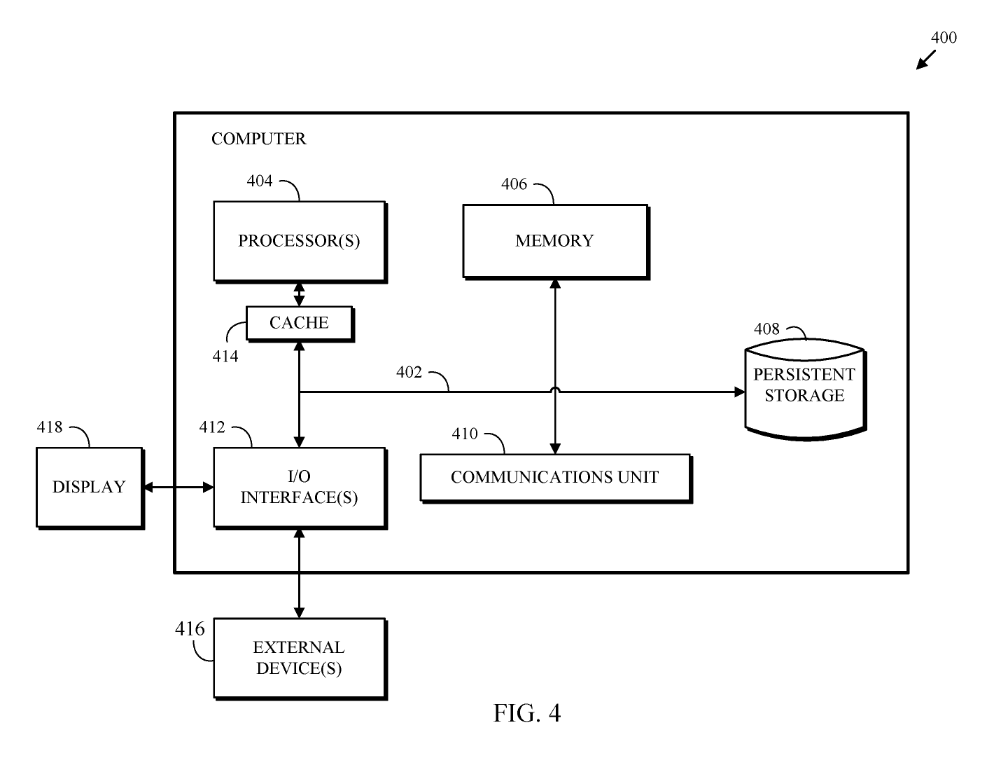

FIG. 4 depicts a functional block diagram of components of a computer system 400, which is an example of systems such as client 110 and server 130 within computing environment 100 of FIG. 1, in accordance with at least one embodiment of the present invention. It should be appreciated that FIG. 4 provides only an illustration of one implementation and does not imply any limitations with regard to the environments in which different embodiments can be implemented. Many modifications to the depicted environment can be made.

Client 110 and server 130 include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., selective encryption method 200 are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client 110 and server 130. In these examples, communications unit 410 includes one or more network interface cards. Communications unit 410 may provide communications through the use of either or both physical and wireless communications links. Program instructions and data used to practice embodiments of selective encryption method 200 may be downloaded to persistent storage 408 through communications unit 410.

I/O interface(s) 412 allows for input and output of data with other devices that may be connected to each computer system. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method executed by one or more processors, the method comprising:
receiving a request to perform selective data encryption on captured content corresponding to a computing device;
determining whether the captured content includes encoded printable characters; and
responsive to determining that the captured content includes the encoded printable characters, encrypting the encoded printable characters within the captured content to provide encrypted captured content.

2. The method of claim 1, wherein the captured content is unformatted.

3. The method of claim 1, wherein the encrypted captured content comprises encrypted encoded printable characters and unencrypted encoded nonprintable characters.

4. The method of claim 1, wherein a beginning and an end of a string of contiguous encoded printable characters are identified.

5. The method of claim 4 wherein the string of contiguous encoded printable characters is encrypted using one encryption operation.

6. The method of claim 1, wherein an encryption key corresponding to the encrypted captured content is provided to a system administrator.

7. The method of claim 1, wherein the encoded printable characters conform to an encoding selected from a group consisting of EBCDIC, ASCII, and Unicode encoding.

8. A computer program product comprising:
one or more computer readable storage media and program instructions stored on the one or more computer readable storage media, the program instructions comprising instructions executable by a computer to perform:
receiving a request to perform selective data encryption on captured content corresponding to a computing device;
determining whether the captured content includes encoded printable characters; and
responsive to determining that the captured content includes the encoded printable characters, encrypting the encoded printable characters within the captured content to provide encrypted captured content.

9. The computer program product of claim 8, wherein the captured content is unformatted.

10. The computer program product of claim 8, wherein the encrypted captured content comprises encrypted encoded printable characters and unencrypted encoded nonprintable characters.

11. The computer program product of claim 8, wherein a beginning and an end of a string of contiguous encoded printable characters are identified.

12. The computer program product of claim 11, wherein the string of contiguous encoded printable characters is encrypted using one encryption operation.

13. The computer program product of claim 8, wherein an encryption key corresponding to the encrypted captured content is provided to a system administrator.

14. The computer program product of claim 8, wherein the encoded printable characters conform to an encoding selected from a group consisting of EBCDIC, ASCII, and Unicode encoding.

15. A computer system comprising:
one or more computer processors;
one or more computer readable storage media;
program instructions stored on the computer readable storage media for execution by at least one of the computer processors, the program instructions comprising instructions to perform:
receiving a request to perform selective data encryption on captured content corresponding to a computing device;
determining whether the captured content includes encoded printable characters; and
responsive to determining that the captured content includes the encoded printable characters, encrypting the encoded printable characters within the captured content to provide encrypted captured content.

16. The computer system of claim 15, wherein the captured content is unformatted.

17. The computer system of claim 15, wherein the encrypted captured content comprises encrypted encoded printable characters and unencrypted encoded nonprintable characters.

18. The computer system of claim 15, wherein a beginning and an end of a string of contiguous encoded printable characters are identified.

19. The computer system of claim 18, wherein the string of contiguous encoded printable characters is encrypted using one encryption operation.

20. The computer system of claim 15, wherein an encryption key corresponding to the encrypted captured content is provided to a system administrator.
